(19) United States
(12) Patent Application Publication
(10) Pub. No.: US 2026/0201749 A1
(43) Pub. Date: Jul. 16, 2026

(54) ELEMENTS FOR CONNECTION TO A WIND TURBINE TOWER

(71) Applicant: Vestas Wind Systems A/S, Aarhus N. (DK)

(72) Inventors: Zuvera Nasreen, Chennai (IN); Nilaventhan Irulappan, Nilakottai (IN)

(73) Assignee: Vestas Wind Systems A/S, Aarhus N. (DK)

(21) Appl. No.: 19/141,107

(22) PCT Filed: Dec. 21, 2023
(86) PCT No.: PCT/DK2023/050326

§ 371 Date: Jun. 19, 2025

(30) Foreign Application Priority Data
Dec. 23, 2022 (IN) 202211074926
Feb. 6, 2023 (DK) PA 2023 70070

(51) Int. Cl. E06C 7/50; F03D 13/10

(52) U.S. Cl. CPC E06C 7/505; F03D 13/122

(57) ABSTRACT

A connector (40) for connecting a bracket (30) to a structure (4) via an anchor member (20). The connector (40) comprises a proximal portion (43) configured to support an end (31) of the bracket (30) in use, and a distal portion (41) which has a curved outer surface (44). The curved surface (44) abuts a surface (24) of the anchor member (20) in use. The bracket (30) comprises an elongate I-beam portion and a portion (50) configured to engage the ladder (10) in use. A kit of parts comprising the connector and a washer configured to conform to the shape of an inner surface (42) of the connector.

### TECHNICAL FIELD

The present disclosure relates to a connector, a bracket, an assembly, and a kit of parts for connecting an item to a structure. In particular, the present disclosure relates to connecting auxiliary items to a wind turbine tower.

### BACKGROUND

Typically, wind turbine towers support a nacelle and rotor of a wind turbine to allow for the rotation of the rotor without risk of ground impact, and to raise the rotor into a position as far as possible from the ground where wind speeds are typically higher and more consistent.

A wind turbine tower may be constructed according to several different principles, for example, as tubular steel towers, lattice towers, or even concrete towers. Most large wind turbines comprise tubular steel towers manufactured in sections of 20-30 meters in length with flanges at either end. The sections are bolted together at the site of the wind turbine installation. Wind turbine towers are typically conical in order to increase strength and save materials.

Steel towers typically comprise an interior with auxiliary items such as ladders, lights, and power cables installed on the inner surface of the tower. Such items may be welded to the inner surface of the tower section, or directly attached to anchor members which are welded and/or bolted to the tower, or which are attached to the tower by one or more magnets.

It is often necessary to provide brackets to span spaces between the item to be connected to the tower and the anchor member. An example of this is for the connection of a ladder to a tower which requires a gap between the ladder and the tower to provide space for foot and hand placement of a person climbing the ladder.

It is challenging to manufacture tower sections of 20-30 metres in length with total conformity to design specifications. As such, manufactured tower sections may have cross-sections which are not completely circular. Such non-conformities can make the installation of auxiliary items difficult, as the designed connection points may not align with the realised connection points of the assembled tower.

In addition, wind loads experienced by the tower in use may cause the tower to flex and bend such that connections between the tower and auxiliary items may be put under excessive loads leading to failure.

It is against this background that the invention has been devised.

### SUMMARY OF THE INVENTION

According to one aspect of the invention a connector for connecting a bracket to a structure via an anchor member is provided; the connector comprising: a proximal portion configured to support an end of the bracket in use; and a distal portion having a curved outermost surface, wherein the curved outermost surface of the distal portion is configured to abut a surface of the anchor member in use.

Such an arrangement provides the benefit that the outermost curved surface of the connector is able to bear against the outer surface of the anchor member, and transmit loads to the tower structure, in a range of angular positions relative to the outer surface. This is advantageous as it provides compensation for any difference in angle between the outer surface of the anchor member and the bracket resulting from manufacturing non-conformities or tower bending.

In an alternative example, the anchor member may be a bolt or clip connected directly to the inner surface of the tower (for example by welding), and the curved outermost surface of the connector may directly abut the inner surface of the tower in use.

Optionally the distal portion of the connector comprises an engagement feature which is configured to operatively engage the anchor member in use to secure the connection between the connector and the anchor member. The engagement feature may be a recess in the surface of the anchor member which is configured to conform to the curved outermost surface of the connector.

The engagement feature optionally comprises a hole which extends from the curved outermost surface to a second surface located proximally of the curved outermost surface. This arrangement is beneficial when the anchor member is, or comprises, a bolt.

The hole may be an elongate hole to compensate for any difference in angle between the surface of the anchor member, or inner surface of the tower, and the bracket resulting from manufacturing non-conformities or tower bending.

In one example, the second surface may be a curved surface for ease of manufacture and for use with a confirming washer.

According to another aspect of the invention a connector may be provided together with a washer, wherein the washer is configured to conform to the shape of the curved innermost surface of the connector in use. This is beneficial as pressure may be applied to the curved inner surface of the connector uniformly across the surface of the washer.

The washer may be shaped to conform to the innermost surface of the connector prior to installation. Alternatively or additionally, the washer may comprise a deformable material such as a polymer hardened rubber which is able to conform to the shape of the innermost surface in use. The use of a rubber washer is beneficial as it provides damping and isolation of vibrations which arise during operation of the wind turbine.

Optionally, the proximal portion of the connector is configured to permit at least one degree of freedom of relative movement between the connector and the bracket. This is advantageous as the overall length of the bracket and connector assembly may be modified in accordance with the installation conditions in existence at the site of the wind turbine, in particular the distance of the inner surface of the wind turbine tower from item to be connected to it.

The proximal portion of the connector optionally defines an opening configured to receive the end of the bracket in use. Such an arrangement provides the benefit of simple and secure connection. The connector may optionally be U-shaped for ease of manufacture and assembly.

In one example, the proximal portion of the connector may comprise a slot for receiving a slider element connected to the bracket in use. Such an arrangement is beneficial as it limits the extent to which the bracket may be moved with respect to the connector.

Optionally, the slot extends towards the distal portion of the connector to provide length adjustment is the distal direction.

According to a further aspect of the invention an assembly for connecting a ladder to a wind turbine tower via an anchor member is provided; the assembly comprises a connector as described above and a bracket, wherein a distal portion of the bracket is attached to the connector, and a proximal portion of the bracket is configured to operatively engage the ladder in use.

Optionally, the bracket comprises an elongate portion having an I-beam cross-section along at least a portion of its length. This is beneficial as the bracket is better able to withstand bending loads.

The proximal portion of the bracket optionally comprises a hook for engagement with the ladder. This arrangement is beneficial as it provides a simple and secure method of connecting the bracket to the ladder.

The assembly may be connected to a wind turbine tower via an anchor member, wherein the wind turbine tower comprises a magnetic material, and wherein the anchor member comprises at least one permanent magnet portion for facilitating the mounting of the anchor member to the wind turbine tower. The use of a magnetic anchor member is beneficial as I may be readily positioned and re-positioned on the inner surface of the tower.

According to a still further aspect of the invention a kit of parts for connecting a ladder to a magnetic wind turbine tower is provided; the kit comprising: a connector as described above; and a bracket, wherein a distal portion of the bracket is configured for attachment to the connector, and a proximal portion of the bracket is configured to operatively engage the ladder in use; and an anchor member, wherein the anchor member comprises at least one permanent magnet portion for facilitating the mounting of the anchor member to the wind turbine tower.

According to a still further aspect of the invention a kit of parts for connecting a bracket to a structure via an anchor member comprising a bolt is provided; the kit comprising: a washer;

and a connector comprising: a proximal portion configured to support an end of the bracket in use; and a distal portion having a curved outermost surface and a curved innermost surface, wherein a hole for receiving the bolt extends between the curved outermost surface and the curved innermost surface, wherein the washer is configured to conform to the shape of the curved innermost surface.

According to a yet further aspect of the invention a bracket for connecting a ladder to a wind turbine tower in provided, wherein the bracket comprises: an elongate first portion comprising an I-beam portion along at least part of its length, wherein the I-beam portion comprises two opposed flanges separated by a web; and a second portion configured to operatively engage the ladder in use. Optionally, the second portion comprises a hook.

At least one of the flanges of the I-beam portion optionally continue beyond the elongate first portion to form the hook. This arrangement provides a convenient method of manufacture.

Both flanges of the I-beam portion may continue beyond the elongate first portion to form the hook, and the hook may comprise an opening located between the flanges. The continuation of both flanges provides stiffness to the hook portion.

In one example the hook may comprises a free end, wherein at least part of the free end of the hook intersects a plane which is continuous with the web of the I-beam portion. This is advantageous as the bracket is better able to resist bending loads imparted by relative lateral movements between the wind turbine tower and the item connected to the wind turbine tower.

Optional features of the aspects of the invention are set out in the dependent claims. Note that these optional features are combinable with each without limitation, save for the case that a specific limitation is discussed explicitly in the discussion that follows.

### BRIEF DESCRIPTION OF THE DRAWINGS

So that it may be more fully understood, the invention will now be described, by way of example only, with reference to the following drawings, in which like features are assigned like reference numerals, and in which:

FIG. 1 is a front view of a wind turbine;

FIG. 2 is a partial cross-sectional view of the wind turbine tower depicted in FIG. 1;

FIG. 3 is an isometric view of an anchor member for connection to the inner surface of the wind turbine tower;

FIG. 4 is an isometric view of an assembly for connecting a ladder to the inner surface of the wind turbine tower;

FIG. 5 is a detailed view of a distal portion of the assembly of FIG. 4;

FIG. 6 is an isometric view of the connector shown in FIG. 5; and

FIG. 7 is a detailed side view of the distal portion shown in FIG. 5.

### DETAILED DESCRIPTION

The following detailed description refers to the accompanying drawings that show, by way of illustration, specific details and examples in which the invention may be practiced. These examples are described in sufficient detail to enable those of ordinary skill in the art to practice the invention. Other examples may be utilised, and structural changes may be made without departing from the scope of the invention as defined in the appended claims.

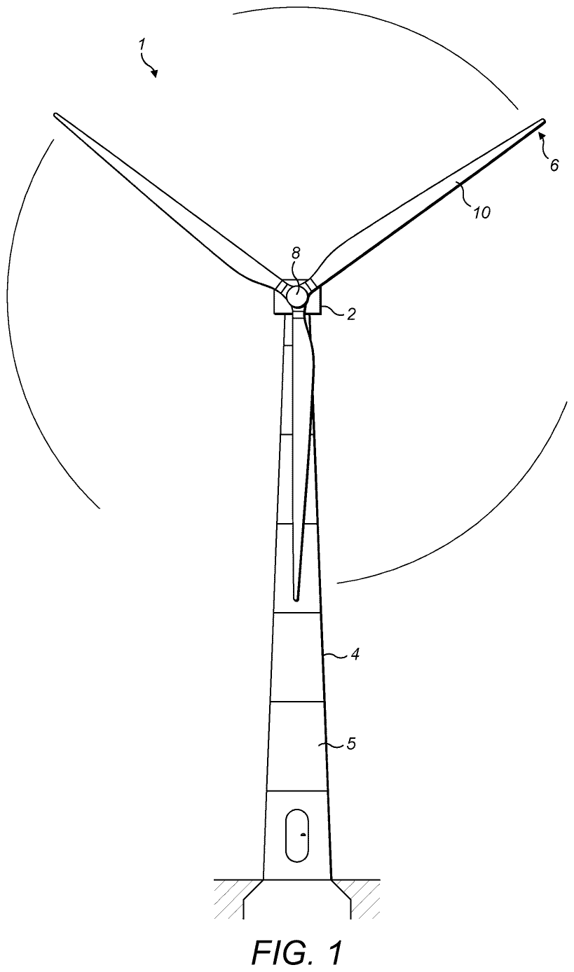

FIG. 1 shows a wind turbine 1. The wind turbine 1 includes a nacelle 2 that is supported on a generally vertical tower 4, which itself comprises a plurality of tower sections 5. The nacelle 2 houses a number of functional components, including a gearbox and a generator (not shown), and supports a main rotor arrangement 6. The main rotor arrangement 6 comprises a hub 8 and a plurality of wind turbine blades 10 connected to the hub 8.

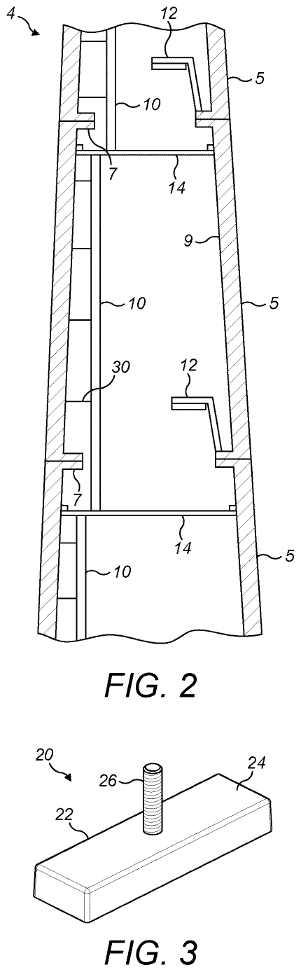

FIG. 2 shows a partial cross-sectional view of the wind turbine tower 4. The wind turbine tower 4 comprises a plurality of conical tower sections 5 made from steel. Each tower section 5 has a flange 7 located at either end. The flanges 7 of neighbouring tower sections 5 are bolted together to form the complete wind turbine tower 4.

In the example of FIG. 2, auxiliary items such as ladders 10, lights 12 and platforms 14 are attached to the inner surface 9 of the tower 4 via anchor members (not shown in FIG. 2). Brackets 30 are employed to span the gap between the ladder 10 and the inner surface 9 of the wind turbine tower 4.

The anchor members may comprise bolts or clips or the like which are bolted or welded or otherwise fixed directly to the wind turbine tower 4. Alternatively, the anchor members may be attached to the tower 4 by one or more magnets. An example of a magnetic anchor member 20 is shown in FIG. 3.

The anchor member 20 comprises a base 22 which comprises an outer surface 24. The base 22 supports a bolt 26 which projects away from the outer surface 24 of the base 22. One or more magnets are located in the base 22. In use, the anchor member 20 is positioned on the inner surface 9 of the wind turbine tower 4 and held in place by the magnets.

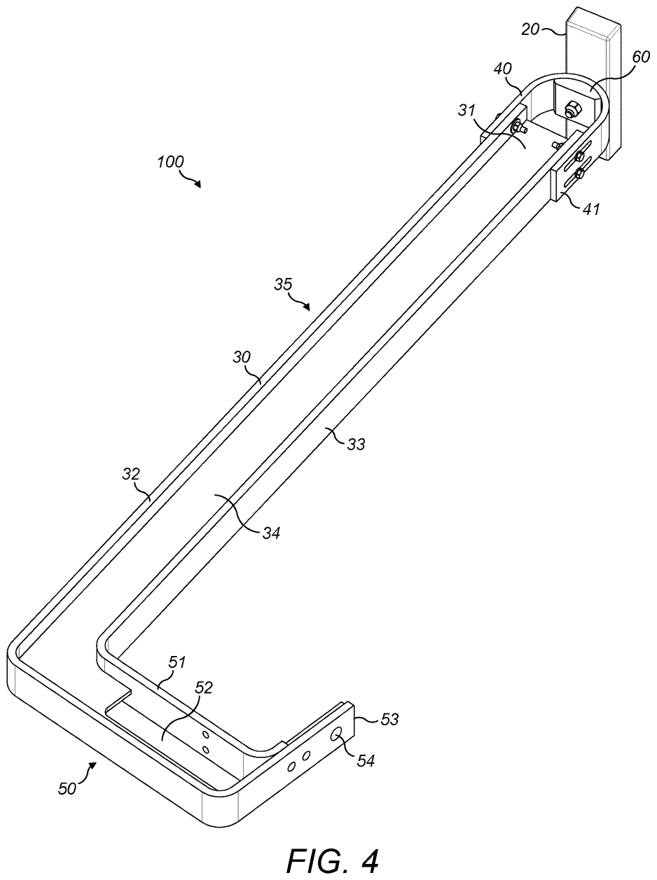

An assembly 100 suitable for attaching a ladder 10 to the inner surface 9 of the wind turbine tower 4 is shown in FIG. 4. The assembly 100 comprises an anchor member 20, a connector 40 and a bracket 30. The bracket 30 comprises a distal portion 31 which is attached to a proximal portion 41 of the connector 40 as will be described in greater detail below.

An elongate first portion 35 of the bracket 30 extends from the distal portion 31 to a second proximal portion 50. The proximal portion 50 is configured in the form of a hook 51 to operatively engage with the ladder 10 in use. It will be understood that the proximal portion 50 of the bracket 30 need not be in the form of a hook 51 and that any other suitable arrangement may be used to attach the proximal end 50 of the bracket 30 to the ladder 10. For example, the proximal end 50 may comprise bolt holes for facilitating connection of the bracket 30 to the ladder 10 by bolts, or the proximal end 50 of the bracket 30 may comprise clips or moveable jaws for operative engagement with the ladder 10.

In the example of FIG. 4, the elongate first portion 35 of the bracket 30 has an I-beam configuration comprising two opposed flanges 32, 33 separated by a web 34. This configuration of bracket 30 is beneficial as the stiffness of the I-beam portion helps to resist bending of the bracket when exposed to loads caused by the wind turbine tower 4 bending in strong winds.

FIG. 4 also illustrates an example of a suitable hook formation. In this example, the hook 51 is formed by a continuation of the flanges 32, 33 of the I-beam portion which continue beyond the elongate first portion 35 to form the hook 51. In the example shown, there is no web between the flange portions 32, 33 forming the hook 51 such that the hook 51 comprises an opening 52 located between the flanges 32, 33. In an alternative example, the web 34 of the I-beam portion may also continue beyond the elongate first portion 35 to form a web portion of the hook 51.

The hook 51 comprises a free end 53 which intersects the plane of the web 34 of the I-beam portion. Consequently, bending loads caused by lateral movements of the ladder 10 are carried by the elongate first portion 35 in the direction of greatest bending stiffness. The bracket 30 is thereby able to effectively resist bending loads imparted by relative lateral movements between the ladder 10 and the wind turbine tower 4.

In the example shown in FIG. 4, the outermost flange 32 of the hook 51 extends beyond the innermost flange 33 of the hook 51 such that the free end 53 of the hook 51 comprises only the outermost flange 32. However, this is not essential and in an alternative example the innermost flange 33 may extend to the free end 53 of the hook 51, or the innermost flange 33 may extend beyond the outermost flange 32. The hook 51 may optionally be provided with holes 54 for receiving fixings for attachment to the ladder 10.

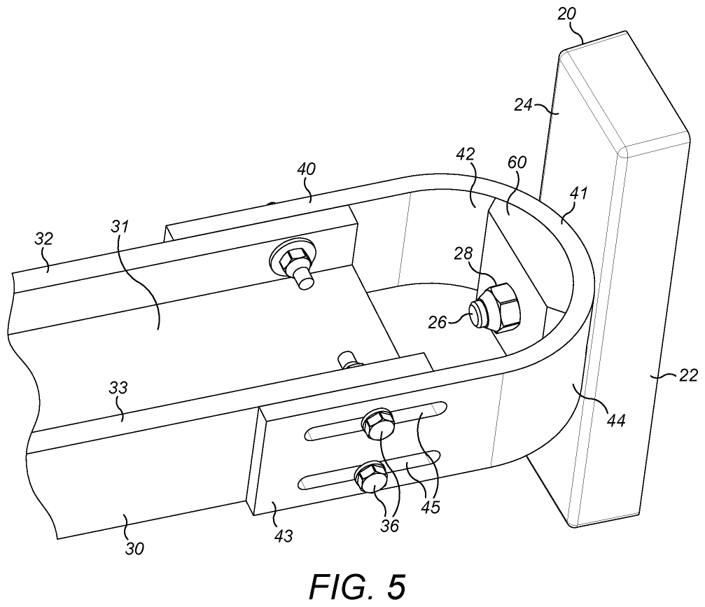

Referring additionally to FIG. 5, a detailed view of the distal portion 31 of the bracket 30 attached to the connector 40 is shown. The connector 40 is in turn attached to a magnetic anchor member 20.

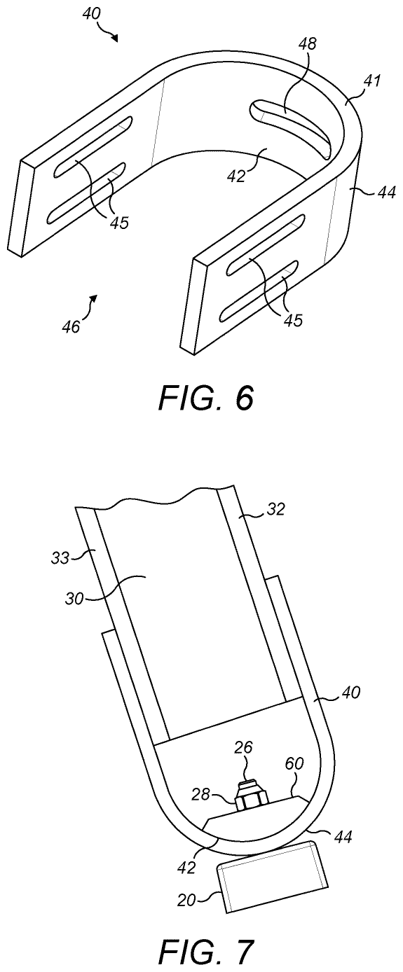

The connector 40 comprises a U-shaped member having a distal portion 41 and a proximal portion 43. The proximal portion 43 of the connector 40 is configured to receive and support the distal portion 31 of the bracket 30. As such, the open end 46 (see FIG. 6) of the U-shaped connector 40 defines an opening configured to receive the distal portion 31 of the bracket 30.

The bracket 30 is attached to the connector 40 via slider elements 36 which are received in distally extending slots 45 located in the proximal portion 43 of the connector 40. The connection between the bracket 30 and the connector 40 is thereby configured to facilitate relative sliding movement between the bracket 30 and the connector 40. This is advantageous as the overall length of the assembly 100 may be modified in accordance with the installation conditions in existence at the site of the wind turbine, in particular the distance of the inner surface 9 of the wind turbine tower 4 from the ladder 10.

In the example shown, the slider elements 36 comprise bolts which engage with the flanges 32, 33 of the I-beam portion of the bracket 30. In an alternative example, the bolts 36 could be replaced by lugs which are integrally formed with the bracket 30.

It will be understood that the example shown in FIG. 5 and described above is illustrative only and that other schemes for enabling relative movement between the bracket 30 and the connector 40 are envisaged. For example, the distal portion 31of the bracket 30 may be received in a cup shaped connector and allowed to slide relative to the connector with or without slider elements and associated slots. If no slider elements are used, the bracket 30 may also rotate, as well as slide, relative to the connector 40. A flange or circlip arrangement may be used to prevent the bracket 30 from sliding out of the connector 40 as is well know to persons skilled in the art. In a further alternative, the proximal portion of the connector may comprise a pin which is received inside the distal portion of the beam 30 to allow relative movement therebetween.

As shown in FIG. 6, the connector 40 comprises an elongate hole 48 located in the distal portion 41 of the connector 40. The hole 48 extends from a curved outermost surface 44 of the connector to a curved innermost surface 42 of the connector. As shown in FIGS. 5 and 7, in use, the bolt 26 of the anchor member 20 passes through the hole 48 and is secured in place by a washer 60 and a nut 28.

When attached to the anchor member 20, the outermost curved surface 44 of the connector 40 abuts the outer surface 24 of the base 22 of the anchor member 20. The outermost curved surface 44 of the connector 40 is thereby able to bear against the outer surface 24 of the anchor member 20, and transmit loads to the tower structure via the anchor member 20, in a range of angular positions relative to the outer surface 24. This is advantageous as it provides compensation for any difference in angle between the outer surface 24 of the anchor member 20 and the bracket 30 resulting from manufacturing non-conformities or tower bending.

The connector 40 comprises two features which are configured to operatively engage the anchor member 20 in use. The first being the curved outermost surface 44 which is configured to abut the outer surface 24 of the anchor member 20, and the second being the hole 48 for engagement with the bolt 26 of the anchor member 20. In an alternative example, the hole 48 may be circular in cross-section with any angular difference between the bolt axis and the hole axis being compensated for by flexibility between the bolt 26 and its connection to the base 22 of the anchor member 20. In a further alternative example, the connector 40 may be attached to the anchor member 20 by magnetism. In this case, the bolt 26 may be dispensed with if desired. The outermost surface 24 of the anchor member may be shaped to receive the curved outermost surface 44 of the connector.

As shown in FIGS. 5 and 7. The washer 60 is configured to conform to the shape of the curved innermost surface 42 of the connector 40. This is beneficial as pressure may be applied to the inner surface 42 of the connector 40 uniformly across the surface of the washer 60. The washer 60 may be shaped to conform to the innermost surface 42 of the connector 40 prior to installation. Alternatively or additionally, the washer 60 may comprise a deformable material such as a polymer hardened rubber which is able to conform to the shape of the innermost surface 42 in use. The use of a rubber washer is beneficial as it provides damping and isolation of vibrations which arise during operation of the wind turbine 1.

In an alternative example, the innermost surface 42 of the connector may be flat and a flat washer may be used.

In the above description the connector 40 is connected to an anchor member 20 comprising a base portion 22 and the bolt 26. It will be appreciated that this is not essential and that the anchor member may comprise a bolt or clip which is connected directly to the inner surface 9 of the tower 4. In this case, the curved outermost surface 44 of the connector 40 directly abuts the inner surface 9 of the wind turbine tower 4.

1. A connector (40) for connecting a bracket (30) to a structure (4) via an anchor member (20); the connector (40) comprising:
a proximal portion (43) configured to support an end (31) of the bracket (30) in use; and
a distal portion (41) having a curved outermost surface (44),
wherein the curved outermost surface (44) of the distal portion (41) is configured to abut a surface (24) of the anchor member (20) in use.

2. The connector (40) of claim 1, wherein the distal portion (41) of the connector (40) comprises an engagement feature (44, 48) which is configured to operatively engage the anchor member (20) in use.

3. The connector of claim 2, wherein the engagement feature comprises a hole (48) which extends from the curved outermost surface (44) to a second surface (42) located proximally of the curved outermost surface (44).

4. The connector (40) of claim 3, wherein the hole (48) is an elongate hole.

5. The connector (40) of claim 3 or 4, wherein the second surface (42) is a curved surface.

6. The connector (40) of claim 5 and a washer (60), wherein the washer (60) is configured to conform to the shape of the curved innermost surface (42) of the connector (40) in use.

7. The connector (40) any one of the preceding claims, wherein the proximal portion (43) of the connector (40) is configured to permit at least one degree of freedom of relative movement between the connector (40) and the bracket (30).

8. The connector (40) of any one of the preceding claims, wherein the proximal portion (43) of the connector (40) defines an opening (46) configured to receive the end (31) of the bracket (30) in use.

9. The connector (40) of claim 8, wherein the connector (40) is U-shaped.

10. The connector (40) of any one of the preceding claims, wherein the proximal portion (43) of the connector comprises a slot (45) for receiving a slider element (36) connected to the bracket (30) in use.

11. The connector (40) of claim 10, wherein the slot (45) extends towards the distal portion (41) of the connector (40).

12. An assembly for connecting a ladder (10) to a wind turbine tower (4) via an anchor member (20); the assembly comprising the connector (40) of any one of claims 1 to 11 and a bracket (30), wherein a distal portion (31) of the bracket (30) is attached to the connector (40), and a proximal portion (50) of the bracket (30) is configured to operatively engage the ladder (10) in use.

13. The assembly of claim 12, wherein the bracket (30) comprises an elongate portion (35) having an I-beam cross-section along at least a portion of its length.

14. The assembly of claim 13, wherein the proximal portion (50) of the bracket (30) comprises a hook (51) for engagement with the ladder (10).

15. The assembly of any one of claims 12 to 14 connected to a wind turbine tower (4) via an anchor member (20), wherein the wind turbine tower (4) comprises a magnetic material, and wherein the anchor member (20) comprises at least one permanent magnet portion (22) for facilitating the mounting of the anchor member (20) to the wind turbine tower (4).

16. A kit of parts for connecting a ladder (10) to a magnetic wind turbine tower (4); the kit comprising:
a connector (40) according to any one of claims 1 to 11; and
a bracket (30), wherein a distal portion (31) of the bracket is configured for attachment to the connector (40), and a proximal portion (50) of the bracket (30) is configured to operatively engage the ladder (10) in use; and
an anchor member (20), wherein the anchor member (20) comprises at least one permanent magnet portion (22) for facilitating the mounting of the anchor member (20) to the wind turbine tower (4).

17. A kit of parts for connecting a bracket (30) to a structure (4) via an anchor member (20)
a washer (60); and
a connector (40) comprising:
a proximal portion (43) configured to support an end (31) of the bracket (30) in use; and
a distal portion (41) having a curved outermost surface (44) and a curved innermost surface (42), wherein a hole (48) for receiving the bolt (26) extends between the curved outermost surface (44) and the curved innermost surface (42), wherein the washer (60) is configured to conform to the shape of the curved innermost surface

(42).

18. A bracket (30) for connecting a ladder (10) to a wind turbine tower (4), wherein the bracket (30) comprises:
an elongate first portion (35) comprising an I-beam portion along at least part of its length, wherein the I-beam portion comprises two opposed flanges (32, 33) separated by a web (34); and
a second portion (50) configured to operatively engage the ladder (10) in use.

19. The bracket (30) of claim 18, wherein the second portion (50) comprises a hook (51).

20. The bracket (30) of claim 19, wherein at least one of the flanges (32, 33) of the I-beam portion continue beyond the elongate first portion (35) to form the hook (51).

21. The bracket (30) of claim 20, wherein both flanges (32, 33) of the I-beam portion continue beyond the elongate first portion (35) to form the hook (51), and wherein the hook (51) comprises an opening (52) located between the flanges (32, 33).

22. The bracket (30) of any one of claims 19 to 21, wherein the hook (51) comprises a free end (53), wherein at least part of the free end (53) of the hook (51) intersects a plane which is continuous with the web (34) of the I-beam portion.
